(19) United States
(12) Patent Application Publication
(10) Pub. No.: US 2017/0202187 A1
(43) Pub. Date: Jul. 20, 2017

(54) Non-lethal method to permanently remove honey bees from their nest

(71) Applicant: Horacio Acevedo, Princeton, TX (US)

(72) Inventor: Horacio Acevedo, Princeton, TX (US)

(21) Appl. No.: 15/001,150

(22) Filed: Jan. 19, 2016

(51) Int. Cl. A01K 55/00; A01K 57/00

(52) U.S. Cl. CPC A01K 55/00; A01K 57/00

(57) ABSTRACT

A method for using a bee removal strip to permanently and non-lethally remove honey bees from their nest.

### FIELD OF THE INVENTION

The present invention relates generally to insect control and more particularly to a method for permanently and non-lethally removing honey bees from their nest.

### BACKGROUND

Honey bees are extremely valuable flying insects. Their survival is imperative to the environment and in particular to our food supply, as they pollinate more than one-third of the world's crops, such as; fruits, vegetables and nuts.

Also, honey bees produced honey, which is a key ingredient in the preparation of many foods, and it is also directly consumed by many people around the world.

Unfortunately, honey bees can be extremely defensive of their honey crop, since it is their main source of food, and their survival depends on it.

In many cases, honey bees built their nests in urban areas in structures such as homes, miscellaneous buildings, hollow trees and many other places. Their defensiveness becomes a serious thread to people and pets in proximity to their nests, and in some cases with lethal consequences. This threat makes it necessary to eradicate these bees from their nests.

Before the bee removal strip method was developed be the inventor, there were just two main methods for permanently eradicating honey bee nests from unwanted locations. The first method consists of opening the structure where the bee's nest is, removing the nest, and relocating the nest to a man-made bee hive. This is usually done by a professional pest control operator, and it is usually a labor intensive and expensive method. The second method, and the least desirable, is to inject a pesticide inside the structure where the honey bee's nest is and poison the bees. This method is cheaper, but environmentally harmful.

With the invention of the bee removal strip method, the honey bees are exposed to a very low dose of repulsive fumes, and given the opportunity to abandon the nest.

Man has learned over the years to keep bees in managed environments, and used them for very worthwhile purposes such as the pollination of crops and the production of surplus honey. Very practical box structures, bee hives, have been created to house managed honey bees and to facilitate the transportation of bees to crop fields for pollination purposes. Also, these hives facilitate the production and extraction of surplus honey. Several inventions have been documented and may be presently in use to temporarily remove the bees from the honey supers in the man-made bee hives, with the purpose of extracting the honey from the bee-free honey comb there after. The following three paragraphs are examples of these inventions.

U.S. Pat. No. 3,122,473 discloses a method of driving honey bees away from the honey supers in a bee hive, with the object of extracting the honey from the honey comb once the bees have been made to vacate the honey supers.

The bee repellent article has an absorbent material impregnated with a diluted solution of organic acids and derivatives thereof. The active bee repellent ingredient is selected from acetic and propionic acids, and derivatives thereof. The method of the invention to drive bees away from the honey supers in a bee hive includes introducing an absorbent material saturated with a low concentration of fatty acid into the vicinity of the bees, may be placed in the bee hive near the honey super, and the repellent allowed to volatilize, causing the bees to vacate the honey super being treated.

U.S. Pat. No. 1,999,890 discloses a method of driving honey bees away from the honey supers in a bee hive, with the object of extracting the honey from the honey comb once the bees have been made to vacate the honey supers.

This invention comprises using a metallic pan-like structure to be heated with with a heating medium such as hot water or steam, and provided with a sheet or layer of some liquid absorbent material such as a piece of cotton flannel that will absorb some readily heat-vaporized liquid such as carbolic acid from which fumes will be generated of given off by reason of the close proximity thereof to the heating medium. These fumes or vapors being disseminated through the honey super will drive the bees therefrom. The fume generating agent is sprinkled on the sheet of absorbent material.

U.S. Pat. No. 2,400,674 discloses a method of driving honey bees away from the honey supers in a bee hive, with the object of extracting the honey from the honey comb once the bees have been made to vacate the honey supers.

This invention comprises using a frame carrying therein a plurality of troughs and a fabric pad mounted over this trough assembly for receiving and holding a sprayed solution of carbolic acid and water, or other suitable solution, with the object of introducing the acid fumes down into the honey super(s) in a bee hive, for the stated purpose of driving the bees therefrom. This trough assembly and fabric pad sprayed with a solution of carbolic acid and water are to be positioned on top of the honey super(s) and under the conventional bee hive lid. Once the honey bees vacate the honey super and migrate down into the bee hive brood box, the now free of bees honey comb can be removed and the honey extracted.

U.S. Pat. No. 6,582,714 discloses an insect control article to control flying insects. The insect control article has a substrate that is impregnated with an active insect control ingredient that is available for passive evaporation. The active insect control ingredient is selected from the group consisting of transfluthrin, prallethrin, tefluthrin, esbiothrin, and combinations thereof. The method of the invention for controlling flying insects includes providing an insect control article having a substrate that is impregnated with an active insect control ingredient available for passive evaporation, wherein the active insect control ingredient is selected from the group consisting of transfluthrin, prallethrin, vaporthrin, teflurthrin, esbiothrin, DDVP, and combinations thereof. The insect control article is then placed in an environment with air movement in such a manner that the substrate of the insect control article is exposed to the air movement, and the active insect control ingredient impregnated within the substrate is allowed to evaporate passively into the air.

### SUMMARY

A method to permanently and non-lethally remove honey bees from their nest by placing a bee removal strip to a target position near the bees nest.

The honey bee removal strip may be placed by a user.

The honey bees from the bees nest may leave the nest in response to the bee removal strip.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an example of a target location for the beehive of the present invention.

FIG. 2 illustrates the method steps of the present invention.

### DETAILED DESCRIPTION

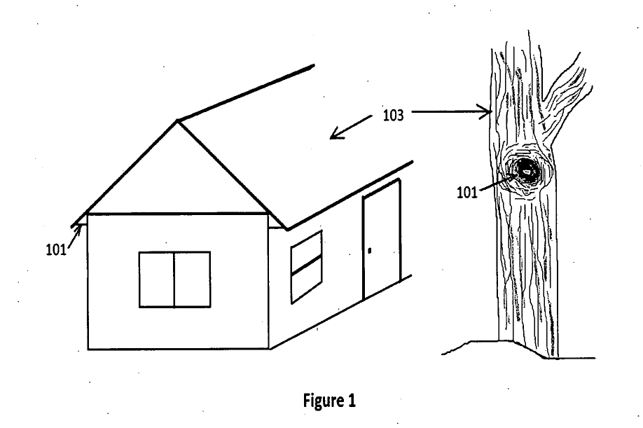

FIG. 1 illustrates structure 103 which may be a home, miscellaneous buildings, trees, etc, which may include a target location 101 which may be a position under the eaves of the structure 103, or inside a hollow tree which may include a nest of honey bees to be permanently and non-lethally removed.

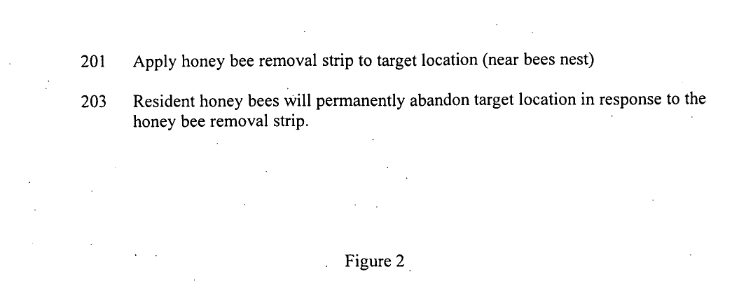

FIG. 2 illustrates the steps of the present invention to permanently and non-lethally remove the resident honey bees from the target location 101.

In step 201, the user may apply a bee removal strip which may be an impregnated strip of absorbent material and may include DICHLORVOS (2.2 Dichloro-Vinyl Dimethyl Phosphate) insect repellent. The bee removal strip may be placed at the target location 101 or near the target location 101. The chemical impregnated in the removal strip is subjected to passive evaporation. The chemical vapors emitted from the strip are repulsive to honey bees, causing the resident honey bees to permanently abandon their nest. The resident honey bees may be referred to as the bees which are inhabiting the nest of bees.

The resident honey bees may leave the target location 101 in response to the presence of the bee removal strip in step 203.

While the invention is susceptible to various modifications and alternative forms, specific embodiment thereof have been shown by way of example in the drawings and are herein described in detail. It should be understood, however, that the description herein of specific embodiment is not intended to limit the invention to the particular forms disclosed.

The inventor has been an active beekeeper for the past 25 years, and owns a pest control company licensed by the state of Texas for over 12 years. The inventor has been successfully using the claimed invention in his bee removal business hundreds of times for the past six years, since the idea was conceived, to permanently and non-lethally remove resident honey bees from their nest. It is important to note, the bee removal method depicted in this invention should not be used to remove honey bees from honey supers in bee hives with the intention of extracting honey. The chemical used in the removal strip to repel the bees may contaminate the honey and make it unsuitable for human consumption.

1) A method to permanently and non-lethally remove honey bees from their nest by placing a bee removal strip at a target position near the honey bees nest.

2) A method to permanently and non-lethally remove honey bees from their nest as in claim 1, wherein the bee removal strip is placed by a user.

3) A method to permanently and non-lethally remove honey bees from their nest as in claim 1, wherein the bees abandon their nest in response to the bee removal strip.
Note: for the purpose of this invention, NON-LETHALLY should be understood as the overwhelming majority of the honey bees from the nest surviving the removal process.
